(19) United States
(12) Patent Application Publication
(10) Pub. No.: US 2009/0155428 A1
(43) Pub. Date: Jun. 18, 2009

(54) Encapsulation of Flavor Components

(76) Inventors: Cheryl R. Mitchell, Stockton, CA (US); Deepthi Kumar Weerasinghe, Brookfield, CT (US); James B. Mitchell, Manteca, CA (US)

Correspondence Address: SUTHERLAND ASBILL & BRENNAN LLP, 999 PEACHTREE STREET, N.E., ATLANTA, GA, 30309, US

(21) Appl. No.: 12/336,013

(22) Filed: Dec. 16, 2008

Related U.S. Application Data
(60) Provisional application No. 61/014,284, filed on Dec. 17, 2007.

(51) Int. Cl. A23P 1/04; A23L 1/09

(52) U.S. Cl. 426/103; 426/302

(57) ABSTRACT

Methods are provided for encapsulating flavor components. The methods may include the steps of providing a flavor component; mixing the flavor component with a syrup comprising carbohydrates and water to form a blend; and removing water from the blend at a temperature less than the melt temperature of the blend to form an encapsulated flavor composition. Encapsulated flavor compositions also are provided. The composition may include an amorphous glass core comprising at least one carbohydrate, water, and at least one flavor component; and a crystalline amylose skin, wherein the crystalline amylose skin surrounds the amorphous glass core.

### CROSS REFERENCES TO RELATED APPLICATIONS

This application claims priority to U.S. Provisional Patent Application No. 61/014,284 filed on Dec. 17, 2007, which is incorporated herein by reference in its entirety.

### FIELD OF THE INVENTION

The present invention relates to encapsulated flavor components and methods of encapsulating flavor components.

### BACKGROUND

Flavor components are used to increase the acceptability of a variety of products including foods, beverages, home care products, and body care products. Unfortunately, the stability of these components may be limited due to oxidation, evaporation, or volatilization. As a result, foods and beverages may suffer from problems such as flavor loss, and home and body care products may suffer from problems such as fragrance loss, especially during long term storage and shipping. What is desired, therefore, is a method of encapsulating flavor components that improves their long term stability.

Previous methods of encapsulation require mixing flavor components with carbohydrates either (a) at very high temperatures and concomitant high pressures or (b) in the presence of large amounts of water, and then drying the mixture with sophisticated equipment such as spray dryers, vacuum dryers, or freeze dryers. Unfortunately, the sophisticated equipment and large amounts of energy required for heating and drying make these methods inefficient, expensive, and/or difficult to use. Furthermore, due to the properties of the carbohydrates used, the end products produced with these methods may be hygroscopic, and thus unstable in high humidity. What is desired, therefore, is an efficient, simple, and/or cost effective method of encapsulating flavor components that improves their long term stability at high levels of humidity.

### SUMMARY OF THE INVENTION

The present invention provides a method of encapsulating a flavor component. In one exemplary embodiment, the method includes providing a flavor component; mixing the flavor component with a syrup comprising carbohydrates and water to form a blend; and removing water from the blend at a temperature less than the melt temperature of the blend to form an encapsulated flavor composition. In another embodiment, the method includes providing a flavor component; mixing the flavor component with a syrup comprising amylose and water to form a blend, wherein the syrup comprises water in an amount in a range from about 15% to about 30% by weight, and wherein the mixing comprises mixing at a temperature in a range from about 5° C. to about 25° C.; and removing water from the blend to form an encapsulated flavor composition.

The present invention also provides an encapsulated flavor composition. In an exemplary embodiment, the composition includes an amorphous glass core comprising at least one carbohydrate, water, and at least one flavor component; and a crystalline amylose skin, wherein the crystalline amylose skin surrounds the amorphous glass core.

### BRIEF DESCRIPTION OF THE DRAWINGS

FIG. 1 shows one embodiment of refractance drying.

FIG. 2 shows one embodiment of an encapsulated flavor component.

### DETAILED DESCRIPTION

Reference now will be made in detail to various aspects of this invention, including the presently preferred embodiments. Each example is provided by way of explanation of embodiments of the invention, not limitation of the invention. In fact, it will be apparent to those skilled in the art that various modifications and variations can be made in the present invention without departing from the spirit or scope of the invention. For instance, features illustrated or described as part of one embodiment can be used on another embodiment to yield a still further embodiment. Thus, it is intended that the present invention cover such modifications and variations within the scope of the appended claims and their equivalents.

Methods have been developed according to aspects of this invention for encapsulating a flavor component by providing a syrup including a carbohydrate and water, mixing the syrup with the flavor component to form a blend, and removing water from the blend to form an encapsulated flavor composition. Unlike conventional encapsulation methods, which may require high temperatures and concomitant high pressures, large amounts of water, and sophisticated drying equipment, the instant methods can be simply and/or efficiently carried out at low temperatures and with low amounts of water. For example, the mixing step carried out in accordance with certain embodiments of this invention may be conducted at about 15° C. and with less than 30% water by weight. Furthermore, because the encapsulated flavor composition may form a crystalline “skin,” the composition may be easily dried to less than about 5% water by weight, and may be substantially non-hygroscopic. The encapsulated flavor composition also may have a flash point that is significantly higher than the flash point of the flavor component alone, which may allow for less expensive and safer shipping, storage and handling as compared to the flavor component.

As used herein, the terms “comprise,” “comprising,” “include,” and “including” are intended to be open, non-limiting terms, unless the contrary is expressly indicated.

### The Blend

The methods may be used to encapsulate essentially any flavor component. As used herein, the term “flavor component” refers to any substance used to produce taste, aroma, or nutrition in a food, beverage, home product, or body product. According to certain embodiments, the flavor component may be a volatile substance such as acetaldehyde, diacetyl, propylene glycol, or ethanol. In other embodiments, the flavor component may be an essential oil. In still other embodiments, the flavor component may be a nutrient, vitamin, mineral, or nutraceutical. In other embodiments, the flavor component may comprise any combination of the foregoing.

The methods may be particularly useful for encapsulating flavor components which are labile. As used herein, the term “labile” refers to any substance that is susceptible to oxidation, reduction, evaporation, volatilization or other physical or chemical change which results in a loss or diminution of the substance's inherent sensorial properties. For example, many flavor components comprise sulfur and amine chemical components which are highly susceptible to oxidation.

The methods of encapsulating the flavor component includes the step of mixing the flavor component with a syrup to form a blend. As used herein, the term “syrup” refers to any liquid that has a high carbohydrate content. Non-limiting examples of syrups include tapioca syrup, rice syrup, corn syrup, and maple syrup. In certain embodiments, the syrup comprises tapioca syrup. In other embodiments, the syrup comprises rice syrup. The syrup may be organic, free of genetically modified organisms (“GMO free”), Kosher, and/or Halal. Furthermore, the syrup may be considered “Natural” within the Flavor and Extract Manufacturers Association (“FEMA”) guidelines. For example, under the FEMA guidelines tapioca or rice syrup can be claimed as “Natural” while corn maltodextrins are not considered “Natural” due to their production methods

The syrup may include both carbohydrates and water. According to certain embodiments, the syrup may include carbohydrates such as monosaccharides, disaccharides, oligosaccharides, polysaccharides, or any combination thereof. In particular embodiments, the carbohydrates include amylose and/or beta-limit dextrin. The glucose content of the carbohydrates may be less than 5% by weight, and is preferably less than 3% by weight. The water may be present in the syrup in an amount in a range from about 15% to about 30% by weight. In particular embodiments, the water may be present in the syrup in an amount in a range from about 20% to about 25% by weight.

In particular embodiments, the syrup is a hydrolysate syrup. The hydrolysate syrup may have been produced by the enzymatic hydrolysis of a starch. The enzymatic hydrolysis may have been performed using amylase enzymes such as alpha-amylase and/or beta-amylase. In a preferred embodiment, the syrup has been hydrolyzed so as to maximize the amount of beta-limit dextrin and/or amylose within the syrup. Preferably, over 50% of the glucose polymers within the hydrolysate syrup have a degree of polymerization greater than about 10.

The syrup may be sufficiently flowable so as to allow mixing with the flavor component. In preferred embodiments, the syrup has a viscosity in a range from about 10 centipoise to about 3000 centipoise at a temperature of 15° C. The viscosity may be further described using Bostwick viscosity measurements. In particular embodiments, the syrup has a Bostwick viscosity in a range from about 15 cm to about 50 cm per 15 to 50 seconds. The syrup may have a pH in a range from about 7.2 to about 7.8. The syrup may have a dextrose equivalence in a range from about 20 to about 60, and preferably in a range from about 20 to 40, and most preferably in a range from about 20 to 30.

The flavor component and syrup may be mixed using essentially any techniques known in the art. In a particular embodiment, the mixing comprises mixing in a kettle mixer. The mixer may be cooled, pressurized, or operate under a reduced pressure or vacuum. As a result of the viscosity of the syrup, the mixing may be conducted at a temperature in a range from about 5° C. to about 25° C. In one embodiment, the mixing is conducted at a temperature in a range from about 10C to about 20° C. In another embodiment, the mixing is conducted at a temperature of about 15° C.

The Removal of Water from the Blend

Embodiments of this invention include removing water from the blend to form an encapsulated flavor composition. Because of the composition of the blend, the removing step may remove substantially all of the water from the blend. In one embodiment, the step of removing water forms an encapsulated flavor composition that includes water in an amount in a range from about 2% to about 6% by weight. In another embodiment, the step of removing water forms an encapsulated flavor composition that includes water in an amount in a range from about 3% to about 4% by weight. The encapsulated flavor composition may comprise an amorphous glass. As used herein, the term “amorphous glass” refers to a semi-solid, non-liquid, non-crystalline state.

The water may be removed from the blend using essentially any technique known in the art. Non-limited examples of methods of removing water include heat drying and freeze drying. As a result of the composition of the blend, the step of removing water may be carried out at a low temperature. In particular embodiments, the water is removed at a temperature in a range from about 10° C. to about 100° C., and more preferably in a range from about 10° C. to about 80° C. Advantageously, the temperature of the syrup composition during drying may be lower than the melting temperature of the resulting amorphous glass. The removal of the water may be facilitated by increasing the surface area of the blend that is exposed to the atmosphere by mixing the blend, bubbling air through the blend, and/or spreading the blend into a film.

The method for removing the water may include drying. The drying may include spray drying, vacuum drying, and/or freeze drying. In a particular embodiment, the drying is carried out with a converter type dryer that may include an infrared pre-heating section. The drying may include spreading the blend into a sheet on a film, preheating the blend with infrared energy, and then drying the blend with air.

In a preferred embodiment, the drying is carried out with a refractance dryer. As used herein, the term “refractance dryer” refers to a dryer that transfers energy from a liquid to a product through a substantially infrared transparent structure that separates the liquid and product.

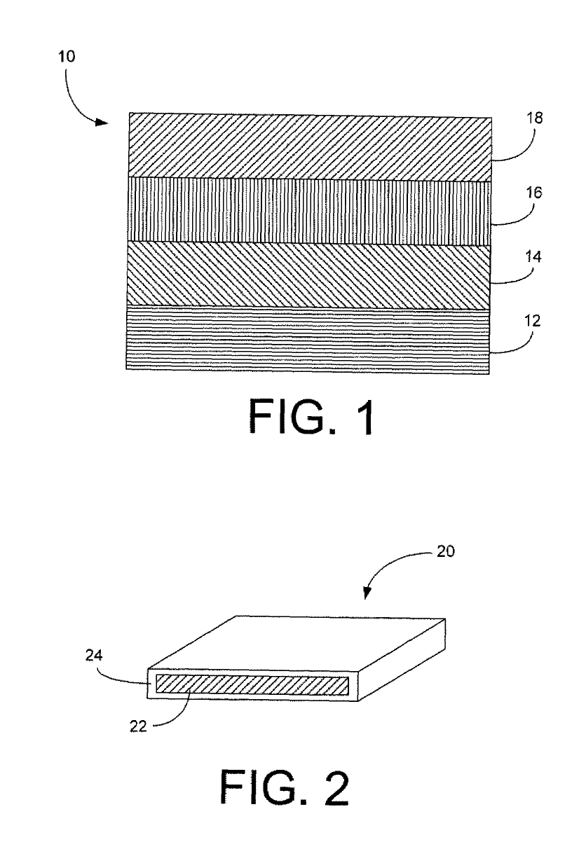

FIG. 1 shows one embodiment of refractance drying. The refractance dryer 10 may include an insulating backing 12 supporting a liquid 14. The liquid 14 may support an infrared transparent structure 16, which may in turn support the blend 18.

As the liquid 14 is heated, infrared energy is transferred through the infrared transparent structure 16. Due to the refractive nature of water, the blend 18 will only absorb refractive energy from liquid 14 until the water in the blend has been removed. When the water has been removed from blend 18, infrared energy can no longer be absorbed from the liquid 14, because the refractive water is no longer present in the blend. As a result, the refractance drying may take place efficiently, and at a very low temperature.

### The Encapsulated Flavor Composition

Also embodied in this invention are encapsulated flavor compositions comprising at least one flavor component. In one embodiment, the encapsulated flavor composition comprises an amorphous glass core comprising at least one carbohydrate, water, and at least one flavor component, and a crystalline amylose skin, wherein the crystalline amylose skin surrounds the amorphous glass core. Because the amylose readily crystallizes and forms an amylose skin and subsequently readily releases water, the encapsulated flavor composition may be easily dried, and may be substantially non-hygroscopic. For example, the composition may include less than 4% water by weight. The skin also may protect the flavor component and/or trap the flavor component within the composition.

According to certain embodiments, the composition includes at least one carbohydrate. The carbohydrate may include monosaccharides, disaccharides, or oligosaccharides, polysaccharides, or any combination thereof. In particular embodiments, the carbohydrates may be predominantly amylose and/or beta-limit dextrin. The glucose content of the carbohydrates may be less than 5% by weight, and is preferably less than 3% by weight. In a particular embodiment, the carbohydrate includes one or more complex carbohydrates in an amount in a range from about 82% to about 98% by weight. The carbohydrates may be derived from a syrup that is formed from the enzymatic hydrolysis of tapioca or rice starch.

The dried composition also may include water. In a particular embodiment, the composition includes water in a range from about 2% to about 6% by weight. In another embodiment, the composition includes water in a range from about 3% to about 4% by weight.

The dried composition also may include a flavor component. As used herein, term “flavor component” refers to any substance used to produce taste, aroma, or nutrition in a food, beverage, home product, or body product. In a particular embodiment, the composition includes flavor component in a range from about 0.01% to about 12% by weight. In another embodiment, the composition includes a flavor component in an amount in a range from about 0.1% to about 10% by weight. According to certain embodiments, the flavor component may be a volatile substance such as acetaldehyde, diacetyl, propylene glycol, or ethanol. In other embodiments, the flavor component may be a flavoring such as an essential oil. In still other embodiments, the flavor component may be a nutrient, vitamin, mineral, or nutraceutical. In other embodiments, the composition may comprise any combination of the foregoing flavor components.

The composition may comprise essentially any form known in the art. Non-limiting examples of suitable forms include powders, granules, and pellets. In a preferred embodiment, the composition is in the form of a plate. The plate may be formed with a refractance or converter dryer as described above.

FIG. 2 shows one embodiment of an encapsulated flavor composition. The encapsulated flavor composition may be in the form of a plate 20. The plate 20 may include an amorphous glass core 22. The glass core 22 may be surrounded by a crystalline amylose skin 24.

The methods and compositions described above will be further understood with reference to the following non-limiting examples.

### Example 1

A syrup prepared by the enzymatic hydrolysis of tapioca starch (pH 7.5, dextrose equivalence 40, glucose content of 3% by weight) including a high level of amylose and about 20% water by weight is mixed with 10% acetaldehyde by weight at 15° C. in a kettle mixture. The resulting blend is dried on a refractance dryer so that the temperature of the composition does not exceed 60° C. in order to form a solid plate with only 2% water by weight. The plate includes an amorphous glass core and a crystalline amylose skin, is substantially non-hygroscopic, and is stable at normal atmospheric temperatures and humidity.

Advantageously, the flash point of the resulting composition is greater than 60° C. Since acetaldehyde has a flash point of 39° C., the composition offers significant economic advantages during shipping as compared to acetaldehyde alone. Specifically, the United States Department of Transportation (DOT) requires that all substances having a flash point lower than 60° C. be handled with “extra caution,” which may significantly increase the cost of shipping and storage.

### Example 2

A syrup prepared by the enzymatic hydrolysis of rice starch (pH 7.5, dextrose equivalence of 40, glucose content 5% by weight) including a high level of amylose and about 20% water by weight is mixed with 10% acetaldehyde by weight at 15° C. in a kettle mixture. The resulting blend is dried by spreading a thin sheet of the syrup of less than 3 mm on a high density polyethylene (HDPE) film and preheating the blend with infrared energy to a temperature that allows for the film to bubble. The film is then dried with 70° C. air so that the temperature of the blend does not exceed 60° C. The drying forms a white solid plate that has 3% water by weight. The plate includes a glass core and a crystalline amylose skin, is substantially non-hygroscopic, and is stable at normal atmospheric temperatures and humidity. The flash point of this composition is greater than 60° C.

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

What is claimed is:

1. A method of encapsulating a flavor component, comprising:
providing a flavor component;
mixing the flavor component with a syrup comprising carbohydrates and water to form a blend; and
removing water from the blend at a temperature less than the melt temperature of the blend to form an encapsulated flavor composition.

2. The method of claim 1, wherein the flavor component is volatile.

3. The method of claim 1, wherein the flavor component is acetaldehyde.

4. The method of claim 1, wherein the syrup comprises the enzymatic hydrolysate of tapioca or rice syrup.

5. The method of claim 1, wherein the syrup comprises amylose.

6. The method of claim 1, wherein the syrup comprises beta-limit dextrin.

7. The method of claim 1, wherein the syrup at a temperature of about 15° C. has a viscosity in a range from about 10 centipoise to about 3000 centipoise or a Bostwick viscosity in a range from about 15 cm to about 50 cm per 15 to 50 seconds.

8. The method of claim 1, wherein the syrup has a dextrose equivalence in a range from about 20 to about 60.

9. The method of claim 1, wherein the syrup comprises carbohydrate in an amount in a range from about 70% to about 85% by weight.

10. The method of claim 1, wherein the syrup comprises carbohydrate in an amount in a range from about 75% to about 80% by weight.

11. The method of claim 1, wherein the syrup comprises glucose in an amount of less than about 5% by weight.

12. The method of claim 1, wherein the syrup comprises water in an amount in a range from about 15% to about 30% by weight.

13. The method of claim 1, wherein the syrup comprises water in an amount in a range from about 20% to about 25% by weight.

14. The method of claim 1, wherein the blend comprises flavor component in an amount in a range from about 0.01% to about 12% by weight.

15. The method of claim 1, wherein the blend comprises flavor component in an amount in a range from about 0.1% to about 10% by weight.

16. The method of claim 1, wherein the mixing step comprises mixing at a temperature in a range from about 5° C. to about 25° C.

17. The method of claim 1, wherein the mixing step comprises mixing at a temperature in a range from about 10° C. to about 20° C.

18. The method of claim 1, wherein the mixing step comprises mixing in a kettle mixer.

19. The method of claim 1, wherein the step of removing water from the blend comprises drying at a temperature in a range from about 10° C. to about 80° C.

20. The method of claim 1, wherein the step of removing water from the blend comprises drying the blend with a refractance dryer.

21. The method of claim 1, wherein the step of removing water from the blend comprises spreading the blend into a sheet, pre-heating the blend with infrared energy, and drying the blend with air.

22. The method of claim 1, wherein the encapsulated flavor composition comprises water in an amount in a range from about 2% to about 6% by weight.

23. The method of claim 1, wherein the encapsulated flavor composition comprises water in an amount in a range from about 2% to about 3% by weight.

24. The method of claim 1, wherein the syrup has a pH in the range of 7.2 to 7.8.

25. A method of encapsulating a flavor component, comprising:
providing a flavor component;
mixing the flavor component with a syrup comprising amylose and water to form a blend, wherein the syrup comprises water in an amount in a range from about 15% to about 30% by weight, and wherein the mixing step comprises mixing at a temperature in a range from about 5° C. to about 25° C.; and
removing water from the blend to form an encapsulated flavor composition.

26. The method of claim 25, wherein the encapsulated flavor composition comprises water in an amount in a range from about 2% to about 5% by weight.

27. An encapsulated flavor composition, comprising:
an amorphous glass core comprising at least one carbohydrate, water, and at least one flavor component; and
a crystalline amylose skin, wherein the crystalline amylose skin surrounds the amorphous glass core.

28. The composition of claim 27, wherein the at least one carbohydrate is present in the composition in an amount in a range from about 82% to about 98% by weight.

29. The composition of claim 27, wherein the water is present in the composition in a range from about 2% to about 6% by weight.

30. The composition of claim 27, wherein the at least one flavor component is present in the composition in an amount in a range from about 0.01% to about 15% by weight.

31. The composition of claim 27, wherein the at least one carbohydrate is from a tapioca or rice based syrup comprising water in an amount in a range from about 15% to about 30% by weight.

32. The composition of claim 27, wherein the at least one flavor component is volatile.

33. The composition of claim 27, wherein the at least one flavor component is acetaldehyde.

34. The composition of claim 27, wherein the encapsulated flavor composition is in the form of a plate.
